(19) United States
(12) Patent Application Publication
(10) Pub. No.: US 2014/0357361 A1
(43) Pub. Date: Dec. 4, 2014

(54) APPARATUS, METHOD AND ARTICLE TO MONITOR GAMEPLAY USING AUGMENTED REALITY

(71) Applicant: Bally Gaming, Inc., Las Vegas, NV (US)

(72) Inventor: Arun Rajaraman, Reno, NV (US)

(73) Assignee: Bally Gaming, Inc., Las Vegas, NV (US)

(21) Appl. No.: 14/290,307

(22) Filed: May 29, 2014

Related U.S. Application Data
(60) Provisional application No. 61/829,077, filed on May 30, 2013.

(51) Int. Cl. G07F 17/32

(52) U.S. Cl. CPC G07F 17/3225
USPC 463/31

(57) ABSTRACT

A portable computing system acquires images representative of a gaming environment (e.g., a gaming table and game participants) and provides augmented reality images including player personal and financial information and/or game or employee related information. The portable computing system can include a tablet form factor computing system having a touchscreen display. Using the acquired images, the game table, game participants, and other objects are identified. Player personal and financial information and/or game information logically associated with the identified game participants and/or objects are retrieved. The player personal and financial information and the game information may be incorporated in real-time or near real-time into the acquired image data to provide an augmented reality monitor useful for monitoring table games.

### BACKGROUND

1. Field

The disclosure is generally related to the gaming industry, and particularly to monitoring game participant and game performance metrics.

2. Description of the Related Art

Many casinos and gaming establishments operate player, patron, or similar reward or incentive programs to recognize and reward to those who patronize the casino or gaming establishment. Such programs may offer a number of different benefits to the program participants. The particular benefits awarded to an individual player may be determined using any number of measured, detected, or inferred metrics, for example the frequency of the player's patronage, the player's wagering habits, and the player's winnings or losses, to provide only a few examples. One such reward may include “points” that a player may redeem within the gaming establishment to access additional gaming opportunities (e.g., plays on a slot machine, etc.). Another reward may include the award of complementary rewards or “comps” to a player that may be redeemed for food, beverages, entertainment events, merchandise, or lodging. Other rewards may include alternative compensatory awards or “alt comps” which are awarded based on a player's loss in the casino, raffle tickets for various goods or services; promotional dollars that may be used for additional gaming; or promotional points that may be used for activities other than gaming. Such reward or incentive programs play an important role in fostering a loyal relationship with players. Such rewards are often tracked using a piece of media such as a magnetic stripe or smart card or similar object that is carried by the player and presented or otherwise read. These cards may, for example be read by scanning a magnetic stripe carried by the card or by using wireless technology such as near field communication, Bluetooth® or the like. The card may be read upon a player's entry to the establishment and/or upon a player's engaging in a table or machine-based game within the establishment.

Additionally, various table game financial and performance metrics are frequently used to provide a window on the operation and profitability of a single table, a group of tables or the gaming floor and/or employees (e.g., dealers). For example, each game table and the attendant game operating personnel such as dealers, croupiers, etc. may be viewed as a financial center that contributes to the overall financial performance of the organization. The compilation of game table performance and financial information may provide an indication of those tables and game operating personnel that are able to consistently offer a positive gaming experience (e.g., high table utilization and efficiency) and a positive financial contribution to the business. Typically, such data indicative of game performance information or game financial information has been compiled and analyzed on a post-hoc or historical basis.

Providing reward or incentive programs as an amenity fosters the development of a logical relationship between a player and a gaming establishment. In many instances, it is a “personal touch” that players will long remember such as a greeting by name, a timely award of a comp after a loss, and the like.

### BRIEF SUMMARY

Providing game operating personnel with the ability to recognize players and have real-time or near real-time access to player personal and financial information can advantageously improve the relationship between the establishment and the player. Providing casino personnel with real-time or near real-time access to dealer, game, or pit performance and financial information may improve the physical and fiscal performance of the game tables across the gaming floor. Such may be difficult to collect, particularly in table gaming. Players and spectators often crowd around table games, particularly when one or more players participating in the game are successful (i.e., “on a roll”). Players may be free to join or leave the game on an almost continuous basis. Additionally, players may be suspect of any data collection devices placed on the table. Further it is often difficult to locate data collection devices to successfully monitor all activity which may occur at a gaming table.

Within the increasing popularity in table games and the growing number of options available to players, it has become more important than ever for gaming establishments to offer unique combinations of services and amenities that encourage regular attendance. Providing personalized services and amenities to players plays an important role in developing a positive relationship that will encourage such regular attendance. Providing a game environment that is cordial and smooth flowing also plays an important role in fostering a positive relationship that encourages regular or repeat attendance by the player.

An augmented reality format monitoring system may be used to advantageously identify and to provide appropriate services and amenities to the players in attendance at a gaming table. The augmented reality based monitoring system may be operated on virtually any portable computing system that is capable of acquiring a number of still or moving (e.g., video) images of the gaming table and the participants. The number of still or video images may be acquired directly, for example using a built-in camera, or indirectly, for example in the form of an image data file or image data stream from one or more networked image acquisition devices. Some or all of the participants in attendance at the gaming table, including both players and game operating staff, may be identified using media carried by the participant, biometric data, other data representative of the participant that is included in the still or video image of the gaming table (e.g., through the use of facial recognition technology), or some combination thereof.

Once identified, the identification information including a participant's name, express or inferred player preferences, and the like may be logically associated with the image of the participant and is displayed in the still or video image of the gaming table provided by the portable computing system on a real-time or near real-time basis. The information is typically displayed spatially proximate an individual or object to which the information pertains. For example, a person's name and wagering habits may be presented in an image of a gaming table positioned spatially proximate the image of the individual. Also for example an amount of a bank or chip tray may be presented in an image of a gaming table positioned spatially proximate the image of the bank or chip tray.

The augmented reality format monitoring system may also be used to deliver real-time or near real-time data indicative of game performance and financial information to game operations or management personnel. Game financial information displayed in an augmented reality format may include metrics such as the buy-in provided by each player at the table, the average wager of each player at the table, the theoretical win associated with each player at the table, the points, comps, alternative comps, promotional prizes, raffle tickets, and the like awarded to the player, or any other or combination of data useful to game operating or management staff in providing a level of service and amenities to each player based on their own preferences and gaming experiences. Game performance information displayed in an augmented reality format may include a chip inventory at the table, a chip inventory or value at the table bank or chip tray, a win/loss record associated with the game operating staff in attendance at the table, a table efficiency (e.g., number of hands, rolls, spins, etc. per defined time period), table occupancy, table utilization, and the like. The timely provision of game performance and financial information to game operating or management personnel may assist in maintaining a smooth game experience by ensuring the timely and unobtrusive replenishment of chips at the table, providing relief of game operating personnel at appropriate times, and the like.

Using an augmented reality format displayed on a portable computing system, all or a portion of the personal and financial information logically associated with some or all of the players in attendance at a game table and all or a portion of the performance and financial information logically associated with the table game played at the game table may be incorporated into acquired still or video image data of the table and the participants. Alternatively, all or a portion of the personal and financial information and all or a portion of the game performance and financial information may be overlaid onto the still or video image data of the table and the participants. The personal and game information incorporated into or overlaid on the acquired still or video image data can provide game operating or management personnel with real-time or near real-time access to information relevant to a game currently played on a game table. The personal and/or game information may be spatially associated by proximity in the digital still or video image with a respective person or object to which the information pertains. The availability of such information can advantageously provide an enjoyable gaming experience for the participants in attendance at the game table while ensuring the smooth flow of the game played in the game table.

A method of operation in an augmented reality based system that employs a tablet form factor processor-based device for monitoring casino gaming may be summarized as including capturing a plurality of images of a gaming area with at least one imager of the tablet form factor processor-based device, the images including at least a portion of a gaming table and one or more participants playing a game at the gaming table; uniquely identifying the gaming table in the captured images; retrieving information about at least one of the game currently being played at the gaming table or at least one of the participants playing the game at the gaming table; logically associating the retrieved information with one or more physical objects represented in the captured images, the physical objects including at least one of: the gaming table, portions of the gaming table, one or more game playing objects on the gaming table, or the participants playing the game at the gaming table; and presenting a number of augmented reality images via a display of the tablet form factor processor-based device, the augmented reality images including an image of at least a portion of the gaming table including the one or more participants along with at least one virtual reality object that is spatially associated in the augmented reality images with respective ones of the one or more physical objects to which the at least one virtual reality object respectively pertains. Uniquely identifying the gaming table in the captured images may include receiving information via a touch screen of the tablet form factor processor-based device that includes a unique gaming table identifier. Uniquely identifying the gaming table in the captured images may include decoding information from a machine-readable symbol that appears in at least one of the captured images. Uniquely identifying the gaming table in the captured images may include wirelessly receiving information from a wireless transponder that is physically associated with the gaming table. Uniquely identifying the gaming table in the captured images may include at least one of receiving geo-location information by the tablet form factor processor-based device, determining a direction by the tablet form factor processor-based device, determining an orientation of the tablet form factor processor-based device.

The method may further include identifying at least one of the participants playing at the gaming table. Identifying at least one of the participants playing at the gaming table may include performing facial recognition on the captured images. Identifying at least one of the participants playing at the gaming table may include determining a name of a respective participant for each of a number of occupied positions at the gaming table by inquiring with a tracking system for names logically associated to the respective positions via patron loyalty tracking information previously read from respective patron loyalty tracking media. Inquiring with a tracking system may include transmitting queries to the tracking system located remotely from the gaming table. Inquiring with a tracking system may include transmitting queries to the tracking system located at the gaming table via short range wireless signals having a range of less than approximately 3 meters. Identifying at least one of the participants playing at the gaming table may include determining a name of a respective participant for each of a number of occupied positions at the gaming table by reading patron loyalty tracking information from patron loyalty tracking media within a range of the tablet form factor processor-based device by the tablet form factor processor-based device. Identifying at least one of the participants playing at the gaming table may include identifying a dealer at the gaming table. Identifying a dealer at the gaming table may include identifying the dealer by sending an inquiry to a back end system by the tablet form factor processor-based device for a dealer identifier logically associated to the respective gaming table at a current time. Identifying a dealer at the gaming table may include reading dealer identification information from a piece of dealer identification media within a range of the tablet form factor processor-based device by the tablet form factor processor-based device. Presenting a number of augmented reality images via a display of the tablet form factor processor-based device may include providing spatially proximate an image of at least one participant or a respective wagering placement area associated with the at least one participant at least one virtual object in the form of a name of that respective participant. Presenting a number of augmented reality images via a display of the tablet form factor processor-based device may include providing spatially proximate an image of at least one participant or a respective wagering placement area associated with the at least one participant at least one virtual object in the form of a current wager amount placed by that respective participant. Presenting a number of augmented reality images via a display of the tablet form factor processor-based device may include providing spatially proximate an image of at least one participant or a respective wagering placement area associated with the at least one participant at least one virtual object in the form of accumulated playing statistics for that respective participant for play over a period of time. Presenting a number of augmented reality images via a display of the tablet form factor processor-based device may include providing spatially proximate an image of at least one participant or a respective wagering placement area associated with the at least one participant at least one virtual object in the form of at least one of average wager, number of hands played, rate of hands played, or average hold amount for that respective participant. Presenting a number of augmented reality images via a display of the tablet form factor processor-based device may include providing spatially proximate an image of at least one participant or a respective wagering placement area associated with the at least one participant at least one virtual object in the form of a notification that the respective participant is banned from play. Presenting a number of augmented reality images via a display of the tablet form factor processor-based device may include providing spatially proximate an image of at least one participant or a respective wagering placement area associated with the at least one participant at least one virtual object in the form of a notification that the respective participant is a highly valued player. Presenting a number of augmented reality images via a display of the tablet form factor processor-based device may include providing spatially proximate an image of at least one dealer or a respective position the at least one dealer occupies a first virtual object in the form of an indication of an efficiency of the dealer at dealing games. Presenting a number of augmented reality images via a display of the tablet form factor processor-based device may include providing spatially proximate an image of at least one dealer or a respective position the at least one dealer occupies at least one virtual object in the form of an indication of win/loss measurement for the dealer. Presenting a number of augmented reality images via a display of the tablet form factor processor-based device may include providing spatially proximate an image of a bank at the table at least one virtual object in the form of an indication of current contents of the bank. Presenting a number of augmented reality images via a display of the tablet form factor processor-based device may include providing spatially proximate an image of a bank at the table at least one virtual object in the form of an indication of a time of last refill of the bank. Presenting a number of augmented reality images via a display of the tablet form factor processor-based device may include providing spatially proximate an image of a bank at the table at least one virtual object in the form of a user selectable icon selection of which produces a refill signal indicative of a request to refill the bank. Presenting a number of augmented reality images via a display of the tablet form factor processor-based device may include providing spatially proximate an image of a bank at the table at least one virtual object in the form of an indication of a fill and credit history for the bank.

Retrieving information about at least one of the games currently being played at the gaming table or at least one of the participants playing the game at the gaming table may include querying a back end system remote from the gaming table for information about at least one of the participants playing the game at the gaming table. Retrieving information about at least one of the games currently being played at the gaming table or at least one of the participants playing the game at the gaming table may include querying a gaming table tracking system at least proximate the gaming table for the information. Retrieving information about at least one of the games currently being played at the gaming table or at least one of the participants playing the game at the gaming table may include retrieving the information from at least one non-transistor processor-readable medium of the tablet form factor processor-based device.

An augmented reality based system to monitor casino gaming may be summarized as including a tablet form factor processor-based device, comprising: at least one processor; at least one non-transitory processor-readable medium communicatively coupled to the at least one processor, and which stores at least one of instructions or data for execution by the at least one processor; at least one imager communicatively coupled to the at least one processor and operable to capture a plurality of images of a gaming area, the images including at least a portion of a gaming table and one or more participants playing a game at the gaming table; at least one display communicatively coupled to the at least one processor, and at least one radio communicatively coupled to the at least one processor; and at least one antenna communicatively coupled to the at least one radio and operable to exchange information with a number of remote devices, wherein the at least one processor: uniquely identifies the gaming table in the captured images; retrieves information about at least one of the game currently being played at the gaming table or at least one of the participants playing the game at the gaming table; logically associates the retrieved information with one or more physical objects represented in the captured images, the physical objects including at least one of: the gaming table, portions of the gaming table, one or more game playing objects on the gaming table, or the participants playing the game at the gaming table; and presents a number of augmented reality images via the display, the augmented reality images including an image of at least a portion of the gaming table including the one or more participants along with at least one virtual reality object that is spatially associated in the augmented reality images with respective ones of the one or more physical objects to which the at least one virtual reality object respectively pertains.

The at least one processor of the tablet form factor processor-based device may receive information via a touch screen of the tablet form factor processor-based device that includes a unique gaming table identifier. The at least one processor of the tablet form factor processor-based device may decode information from a machine-readable symbol that appears in at least one of the captured images and that unique identifies the gaming table. The at least one radio wirelessly may receive information from a wireless transponder that is physically associated with the gaming table and that uniquely identifies the gaming table. The at least one processor of the tablet form factor processor-based device may receive geo-location information, determines a directional bearing, or determines an orientation of the tablet form factor processor-based device.

The at least one processor of the tablet form factor processor-based device may further Identify at least one of the participants playing at the gaming table. The at least one processor of the tablet form factor processor-based device may perform facial recognition on the captured images to identify the at least one of the participants. The at least one processor of the tablet form factor processor-based device may inquire with a tracking system for names logically associated to the respective positions via patron loyalty tracking information previously read from respective patron loyalty tracking media. The at least one processor of the tablet form factor processor-based device may determine a name of a respective participant for each of a number of occupied positions at the gaming table based on patron loyalty tracking information read from patron loyalty tracking media by the at least one radio of the tablet form factor processor-based device. The at least one processor of the tablet form factor processor-based device may identify a dealer at the gaming table. The at least one processor of the tablet form factor processor-based device may send an inquiry to a back end system for a dealer identifier logically associated to the respective gaming table at a current time. The at least one processor of the tablet form factor processor-based device may identify the dealer at the gaming table based on dealer identification information read from a piece of dealer identification media by the at least one radio of the tablet form factor processor-based device. The at least one processor of the tablet form factor processor-based device may cause a presentation of at least one virtual object in the form of a name of a respective participant spatially proximate an image of the respective participant or a respective wagering placement area associated with the respective participant.

The at least one processor of the tablet form factor processor-based device may cause a presentation of at least one virtual object in the form of a current wager amount placed by a respective participant spatially proximate an image of the respective participant or a respective wagering placement area associated with the respective participant. The at least one processor of the tablet form factor processor-based device may cause a presentation of at least one virtual object in the form of accumulated playing statistics for a respective participant for play over a period of time spatially proximate an image of the respective participant or a respective wagering placement area associated with the respective participant. The at least one processor of the tablet form factor processor-based device may cause a presentation of at least one virtual object in the form of at least one of average wager, number of hands played, rate of hands played, or average hold amount for a respective participant spatially proximate an image of the respective participant or a respective wagering placement area associated with the respective participant. The at least one processor of the tablet form factor processor-based device may cause a presentation of at least one virtual object in the form of a notification that a respective participant is banned from play spatially proximate an image of the respective participant or a respective wagering placement area associated with the respective participant. The at least one processor of the tablet form factor processor-based device may cause a presentation of at least one virtual object in the form of a notification that a respective participant is a highly valued player spatially proximate an image of the respective participant or a respective wagering placement area associated with the respective participant. The at least one processor of the tablet form factor processor-based device may cause a presentation of at least one virtual object in the form of an indication of an efficiency of a dealer at dealing games spatially proximate an image of the respective dealer or a respective position the respective dealer occupies. The at least one processor of the tablet form factor processor-based device may cause a presentation of at least one virtual object in the form of an indication of win/loss measurement for a dealer spatially proximate an image of the respective dealer or a respective position the respective dealer occupies. The at least one processor of the tablet form factor processor-based device may cause a presentation of at least one virtual object in the form of an indication of current contents of a bank spatially proximate an image of the bank at the table. The at least one processor of the tablet form factor processor-based device may cause a presentation of at least one virtual object in the form of a time of last refill of a bank spatially proximate an image of the bank at the table. The at least one processor of the tablet form factor processor-based device may cause a presentation of at least one virtual object in the form of a user selectable icon selection of which produces a refill signal indicative of a request to refill a bank spatially proximate an image of the bank at the table. The at least one processor of the tablet form factor processor-based device may cause a presentation of at least one virtual object in the form of an indication of a fill and credit history for a bank spatially proximate an image of the bank at the table. The at least one processor of the tablet form factor processor-based device may query a back end system remote from the gaming table for information about at least one of the participants playing the game at the gaming table. The at least one processor of the tablet form factor processor-based device may query a gaming table tracking system at least proximate the gaming table for the information.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is an isometric view of a gaming environment including a game table and a number of participants including several players and a dealer, and a casino employee operating a portable computing system in the form of a tablet computing device according to one illustrated embodiment.

FIG. 2 is a schematic diagram of a system including a number of portable computing systems, each capable of providing an augmented reality format display, that are communicably coupled to an example back end system, according to one illustrated embodiment.

FIG. 3 is a block diagram of an example portable computing system useful for implementing an augmented reality game monitoring system, according to one illustrated embodiment.

FIG. 4A is a screen print of an example augmented reality format image provided by a portable computing system that shows information logically associated with a game table and each of a number of game players, according to one illustrated embodiment.

FIG. 4B is another screen print of an example augmented reality format image provided by a portable computing system that shows information logically associated with a game table a game player, a dealer, and one or more game objects, according to one illustrated embodiment.

FIG. 5 is a high level flow diagram of a method of providing augmented reality format images on a portable computing system, according to one illustrated embodiment.

FIG. 6 is a flow diagram of a method of manually identifying a gaming table, according to one illustrated embodiment, which may be employed in the performing the table identification of the method of FIG. 5.

FIG. 7 is a flow diagram of a method of autonomously identifying a gaming table, according to one illustrated embodiment, which may be employed in the performing the table identification of the method of FIG. 5.

FIG. 8 is a flow diagram of a method of autonomously identifying participants at a gaming table, according to one illustrated embodiment, which may be employed in the performing the participant identification of the method of FIG. 5.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems or processor based devices, networks, and image acquisition have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, such as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

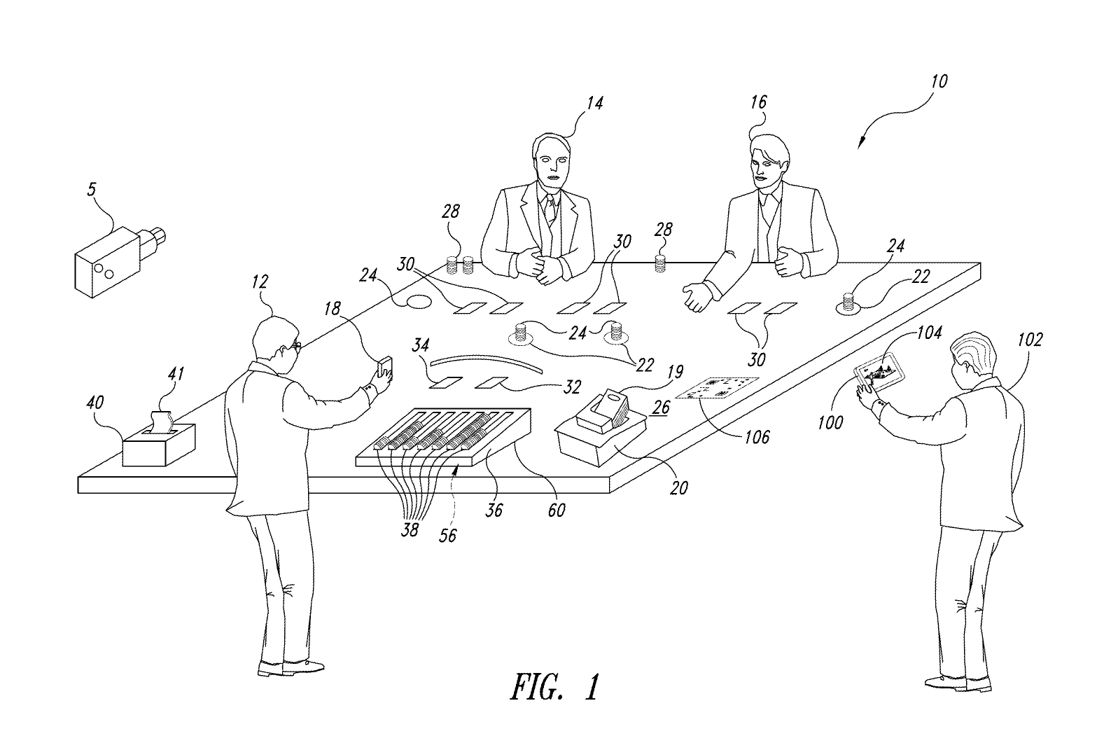

FIG. 1 shows an environment 10, according to one illustrated embodiment, in which a game table and a number of participants engaged in a game played on the game table are monitored using an augmented reality game monitoring system 100. More specifically, FIG. 1 depicts a game of blackjack being played at a game table by a game operator or dealer 12 who may be employed by a gaming house or casino and any number of players. While blackjack is used as an illustrative example in FIG. 1, one of skill in the gaming arts would readily appreciate the advantageous nature and broad applicability of the augmented reality format monitoring systems and methods described herein across a wide variety of table games such as craps, baccarat, Texas Hold 'Em, Pai Gow, Pai Gow poker, stud poker, Let It Ride®, wheel of fortune, and roulette to name only a few.

Additionally, while the augmented reality format monitoring systems and methods described herein are discussed in the context of table gaming, the applicability of such systems and methods is not limited to table games. For example, such augmented reality format monitoring systems and methods may be employed in other gaming locations including unattended gaming locations such as slot machines, video gaming machines, and the like. For instance, such augmented reality format monitoring systems and methods may be used to recognize players engaging in gameplay on such non-table gaming devices and display to game management personnel via a portable computing system 100, the wagering habits or net worth of the player to the casino or gaming establishment.

The participants in the game may include any number of players (only two players 14, 16 are shown in FIG. 1) and any number of gaming staff (only one dealer 12 is shown in FIG. 1). The game operating staff may include, for example a dealer 12, croupier, or any other operating staff member (hereinafter collectively referred to as a “dealer 12”) who administers or otherwise manages the play of the game on the gaming table by distributing or allocating playing pieces and coordinating the collection and distribution of chips, tokens, or similar game related items. Continuing with blackjack as an example, during a round or hand the dealer 12 may periodically remove cards 19 from a card shoe 20. In at least some instances, the dealer 12 may individually draw the cards from the card shoe 20, or can remove an entire deck 18 of cards 19 from the card shoe 20 to deal by hand in accordance with local or house tradition or custom. In fact, some players 14, 16 may prefer the experience of a game where the cards are dealt by the dealer 12 from a handheld deck 18, rather than being individually drawn from the card shoe 20.

The players 14, 16 place their respective wagers by placing a number of wager chips, tokens, checks, cheques, or plaques (collectively, “chips”) 22 in a designated area such as within wager circles 24 located on a playing surface 26 of the gaming table. The chips 22 are typically provided in a variety of denominations to cover wagering from small denominations (e.g., $1) to very large denominations (e.g. $1,000 or more). Players 14, 16 can purchase chips 22 from a teller or, in some establishments, may purchase chips from the dealer 12 at the gaming table. Chips 22 are negotiable instruments that may be redeemed for a cash value by the player. Such redemption services are frequently, though not exclusively conducted at a secured location such as a teller window. In some instances, vouchers, coupons, or similar printed media redeemable for cash or chips 22 may be provided to a player in lieu of chips 22. The chips used by gaming establishments such as casinos typically have different designs, circumferential spots, or patterns to designate different value chips 22 that are used for wagering at table games instead of actual currency. A player 14 can chose to play multiple hands by placing wagers corresponding to each hand played, as shown in FIG. 1. Each of the players 14, 16 will often have a “stack” or reserve of chips 28 from which wagers are placed.

After the players 14, 16 have placed an initial wager of chips 22 in their respective wager circles 24, the dealer 12 deals each player two cards 30 face down, and deals themself one card 32 face down (“hole card”) 32 and one card 34 face up (“show card”) from either the deck 18 or the shoe 20. Dealt cards are assigned a numeric value equivalent to the number of “spots” appearing on the face of the card (e.g., a five of hearts counts as “five”), face cards are assigned a numeric value of ten points, and Aces are assigned a numeric value of either one or eleven at the cardholder's discretion. The players 14, 16 can accept additional cards (“hits”) as they attempt to reach a hand value of “21” without exceeding “21.” An Ace and a card having a value of “10” combine to form a “natural” hand referred to as “Blackjack.” The dealer 12, representing the house, also attempts to reach “21” without going over, although the rules typically require the dealer 12 to take a hit when holding a “soft 17” (i.e., a total hand value of “17” formed using an Ace with a numeric value of “11”). The players 14, 16 can vary their wagers (chips 22) after the initial cards 30-34 are dealt based on their knowledge of their own hand and the dealer's face up card 34. For example, the player 14, 16 can “hit” or “stand” and may “double down” or “buy insurance.”

At the end of a round or game, the dealer 12 collects the wager chips 22 from losing players and pays out winnings in chips to the winning players. The winnings are calculated as a multiple of a set of odds for the game and the amount of the wager chips 22. The losses are typically the amount of the wager chips 22. The dealer 12 places the collected wager chips 22 or “take” from the losing players into a gaming table bank that takes the form of a chip tray 36. The dealer 12 pays out the winnings using the required number of chips 38 from the chip tray 36. The chip tray 36 generally consists of a number of wells, sized to receive the chips 38 with different wells generally used to contain different value chips. Changes to the contents of the chip tray 36 represent the winnings and loses of the casino (“house”) at the gaming table. Thus, maintaining an accurate count of the number and value of the chips 38 in the chip tray 36 can assist the casino in managing its operations. Many casinos permit the dealer 12 to exchange chips for items 41 of value such as currency or other items at the gaming table. The dealer 12 deposits the item 41 of value into a drop box 40 at or near the gaming table. Periodically, for example at the end of a dealer's shift, the contents of the drop box 40 must be reconciled with contents of the chip tray 36, to ascertain that the correct number and value of chips were distributed.

Rapid access to accurate and up-to-date player personal and financial information is essential in the fast moving environment typically found in a casino. Data indicative of such personal and financial information may often be found in the form of data stored on any number of servers or similar nontransitory storage devices. Such nontransitory storage may be disposed in devices or systems located on the gaming floor, located remote from the gaming floor, or any combination thereof. Computing systems, in particular portable computing systems 100, may be used on the game floor by casino personnel 102 such as “floormen,” “pit bosses,” and “pit managers” to access such data indicative of player personal and financial information stored on such remote storage devices. Such portable computing systems 100 may also be used to access game related performance and financial metrics logically associated with one or more game tables to ensure the gaming at each of the respective game tables provides the players with a positive game experience that encourages return visits by the player in the future.

Although a tablet form-factor portable computing system is illustrated for convenience, the portable computing system 100 may include any processor-based device capable of accessing data indicative of player and game information and providing such data to the device user in an augmented reality format where the information is spatially associated with at least one element (e.g., participant, game table) in an acquired still or video image. Such portable computing systems 100 may therefore include, without limitation other computing devices or systems such as handheld computing devices, cellular devices such as smartphones, wearable computing devices such as Google Glass®, or any similar device or system capable of providing a human perceptible output to the user of the portable computing system 100.

In the implementation depicted in FIG. 1, the portable computing system 100 includes a tablet form-factor computing device. The tablet form-factor computing device has an image acquisition device (not visible in FIG. 1) and a display 104 to display or present acquired still or video images in which at least a portion of a gaming environment (e.g., game table) and some or all of the game participants (e.g., the game players 14, 16, and the dealer 12) are visible or represented. Data indicative of personal and game related information is retrieved and logically associated with each of at least some participants or objects that are present in the image. The personal or game related information logically associated with a game participant or game object is provided in an augmented reality format where the information is displayed in the image at a location spatially proximate the participant or object with whom or which the information is logically associated.

The portable computing system 100 is bidirectionally communicably coupled to one or more networks such as a local area network (LAN) within the casino through which additional computing resources and access to stored data indicative of player personal and financial information is provided. In some instances, the portable computing system 100 may also be unidirectionally or bidirectionally communicably coupled to a second network within the casino through which game performance and financial information such as the number of hands per hour; the chip tray inventory; the chip tray value; table utilization; table occupancy; and the like may be accessed.

Data indicative of a player's personal information including the player's name and express or inferred preferences may be provided in, displayed with, or incorporated into the image of the gaming table provided on the display 104 of the portable computing system 100. In at least some implementations, the personal information logically associated with a particular player may be displayed in the image of the gaming table in an augmented reality format image in a location spatially proximate the respective player with whom the personal information is logically associated. Providing such personal information to game management personnel 102 or game operating personnel 12 advantageously enables the operating or management personnel to greet, interact, and provide comps personalized to the player 14, 16 at the gaming table.

Data indicative of a player's financial information, including the value of the player's current chip inventory, the amount of the player's buy-in to the gaming table, the amount won or lost by the player, the wagering pattern of the player, and the like may also be provided in the image of the gaming table provided on the display 104 of the portable computing system 100. The financial information logically associated with a particular player may be displayed in the image of the gaming table in a location proximate the respective player with whom the financial information is associated. Providing such financial information to casino personnel 102 advantageously enables the casino personnel 102 to provide comps based on the financial gain or loss of the player and also can enable casino personnel to proactively detect players demonstrating wagering behaviors requiring intervention by casino personnel (e.g., gambling addiction or the like).

Information logically associated with the dealer 12 may also be included in the augmented-reality format image displayed by the portable computing system 100. Such information may include data indicative one or more performance statistics or metrics logically associated with the dealer 12, for example a win/loss record, the number of card hands dealt per hour, roulette wheel spins per hour, the game table occupancy, the game table utilization, and the like.

Each game table, gaming machine, or gaming device can carry one or more unique identifiers 106. Such identifiers may include any human and/or machine readable code disposed on a surface and in a media visible to at least the portable computing system 100. Using the identifier 106, data indicative of game financial information or performance metrics that is logically associated with the game table, machine, or device may also be included in the image displayed by the portable computing system 100. Such financial information may include a chip tray inventory, a chip tray value, chip tray fill and credit history, and the like. Providing such game performance and financial information to casino personnel 102 advantageously enables casino personnel to detect slow-downs in play, and proactively provide chip tray fills and credits at points in the game selected to minimize the impact of such events on the flow of the game which can provide a more favorable gaming experience to the players 14, 16 in attendance at the game table.

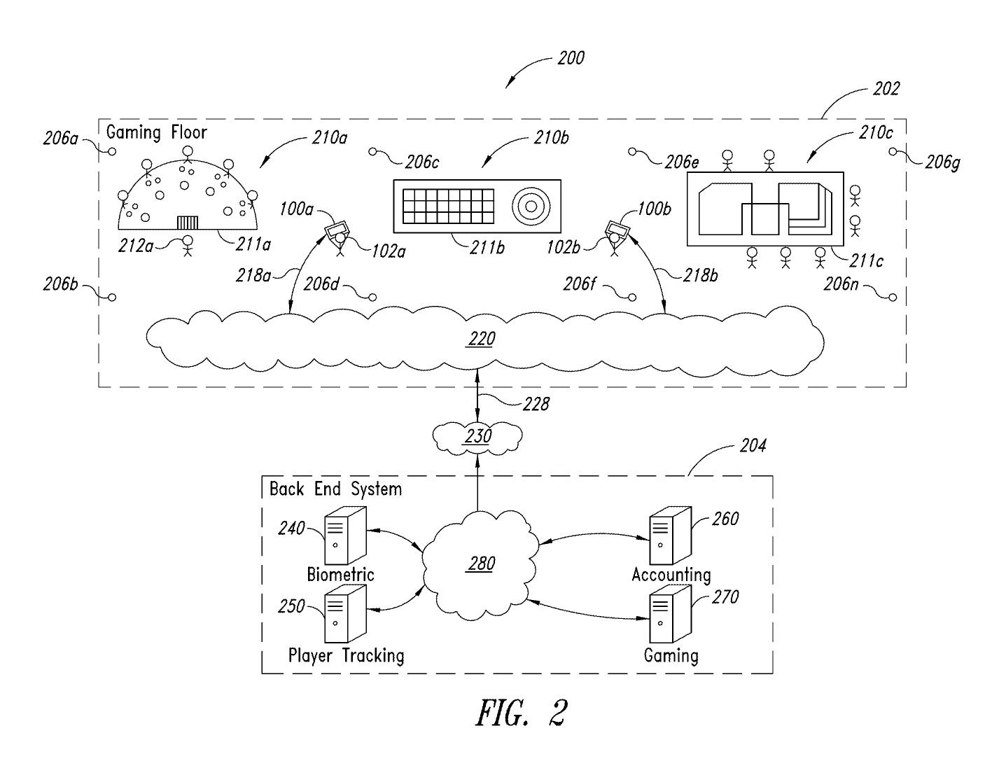

FIG. 2 depicts an example gaming environment 202 in which portable computing systems 100a, 100b are used by game management personnel 102a, 102b (collectively “game management personnel 102”) to monitor a number of table games 210a-210c (collectively “table games 210”). The portable computing systems 100 are wiredly or more preferably wirelessly communicably coupled 218a, 218b to one or more gaming floor networks 220. The one or more gaming floor networks 220 may be wiredly or wirelessly communicably coupled to a back end system 204 via one or more wired or wireless networks 230. The one or more networks 230 may include one or more private or public networks including worldwide network such as the Internet which allows the back end system 204 to be located either proximate or remote from the gaming floor 202.

Although not shown in FIG. 2, the gaming floor network 220 and the back end system 204 may secured or otherwise protected using one or more firewalls, encrypted communications protocols, or other security features to protect the data communicated between the portable computing systems 100 and the back end system 204 from unauthorized access or manipulation.

Each of the portable computing systems 100 may be used to monitor the participants in attendance and the activity on one or more gaming tables 211a-211c (collectively “gaming table(s) 211”). Such gaming table(s) 211 may include, but are not limited to, blackjack tables 211a, roulette tables 211b, and craps tables 211c. In some instances, game management personnel 102 may travel between gaming table(s) 211 and may monitor the ebb and flow the games being played on the gaming table(s) 211 using portable computing systems 100. The portable computing system 100 can facilitate the monitoring of one or more table games or other gaming devices or machines by providing the game operating or management staff 102 with data indicative of real-time or near real-time personal and financial information on the players 214, 216 present at each table as well as win/loss and financial information for the games provided at each gaming table 211. Such data may advantageously facilitate a smooth flowing table game and the provision of personalized service to the players 214, 216 in attendance at each gaming table 211.

Although the back end system 204 is depicted in FIG. 2 as including an individual biometric server 240, an individual player tracking server 250, an individual accounting server 260, and an individual gaming server 270 communicably coupled by a back end network 280, the functionality described below with regard to each of the servers may be combined or divided in any order or proportion across any number or type of computing devices. In some implementations, all or a portion of the functionality described as performed by a back end system may be performed in whole or in part on the portable computing system 100 or an intermediate device not explicitly depicted in FIG. 2.

At least a portion of the still or video image data acquired by the portable computing systems 100 may include data indicative of a unique identifier 106a-106c useful in uniquely determining the identity of a game table 211 appearing in the image. In some implementations, the game table identifier 106 may include one or more machine readable symbols or codes disposed on or about the game table 211. Such machine readable symbols or codes may take the form of bar codes or matrix symbols appearing on one or more surfaces of the game table 210. In at least some implementations, such bar codes or matrix symbols may be rendered in a media that is invisible to the unaided eye, for example using an ink visible in the infrared or ultraviolet electromagnetic spectra.

In other implementations, the unique identifier 106 logically associated with each gaming table, machine, or device may take the form of positional data referenced to either a local coordinate system (e.g., a location on the casino floor triangulated using a matrix of precisely located radio frequency beacons) or an absolute or global coordinate system (e.g., a location detected using a global positioning system or “GPS” receiver). For example, the relative location of a gaming table, machine, or device may be obtained by triangulating its location using a number of radio frequency beacons 206a-206n positioned in known locations on the casino floor 202. Once the relative or absolute location of the gaming table, machine or device is determined, in some instances the unique identifier 106 logically associated with the gaming table, machine or device may be looked-up in or retrieved from a database or similar data store that is indexed by the relative or absolute locations of some or all of the gaming tables, machines, or devices present on all or a portion of the gaming floor 202. Data indicative of such location databases or data stores may be retained or otherwise stored locally within the portable computing system 100; within a remote back end system 204 that is communicably coupled to the portable computing system 100; or some combination thereof. In yet other instances, the relative or absolute location logically associated with each gaming table, machine, or device can provide all or a portion of the unique identifier 106.

Some or all of the still or video image data acquired by the portable computing systems 100 may be communicated to one or more back end devices 204. At least a portion of such image data may contain data representative of the faces or other biometric information that is logically associated with the players 214, 216 present at a gaming table 211. Some or all of such collected facial or biometric information may be communicated to a biometric server 240 in the back end system 204. One or more machine executable instruction sets or programs executed by the biometric server 240 can uniquely identify the players 214, 216 present at the game table 211 based on distinguishing facial or other biometric features. Such identification advantageously does not rely upon the presentation of identifying media such as a player or casino patron card by the player and thus advantageously provides a minimally intrusive way for game operating staff to uniquely identify the players 214, 216 in attendance at a game table 211.

Once identified either through one or more biometric parameters or by a successful read of a player or casino patron card, the personal and financial information logically associated with the identified player may be retrieved from or otherwise obtained from a player tracking server 250. Information retrieved from the player tracking server 250 may include data indicative of comps that have been provided to the player, comps that are due the player, reward point balances, express or inferred personal preferences and the like. Information retrieved from the player tracking server 250 may be provided to the portable computing system 100 for display in an augmented reality format in the real-time or near real-time image of the gaming table 211. Such information may be provided to game operating or management personnel 102 in an augmented reality format image where the information is incorporated into the image displayed on the portable computing system 100 and displayed in a location within the image that is proximate the identified player 214, 216. In at least some instances, the augmented reality format image may be created in whole or in part by the portable computing system 100, the back end system 204, or combinations thereof.

Financial information logically associated with identified player may be retrieved or otherwise obtained from an accounting server 260. Such financial information may include, for example data indicative of a player's wagers, a player's wager pattern, a player's net win or loss, a player's theoretical win, or any other financial data, metrics or analyses based on the financial activities of the player at the gaming table 211. Financial information specific to a gaming table 211 may also be retrieved or otherwise obtained from the accounting server 260. Such financial information may include, for example, a chip inventory, a value of the chip inventory, a chip fill or credit, or the like. Information retrieved from the accounting server 260 may be provided to the portable computing system 100 for display in an augmented reality format in the real-time or near real-time image of the gaming table 211 where the identified player is seated. Financial information logically associated with a particular player 214, 216 may be provided to game operating or management staff 102 in an augmented reality format where the information is incorporated into the image displayed on the portable computing system 100 and displayed in a location proximate the identified player 214, 216. Financial information associated with the gaming table 211 may also be provided in an augmented reality format and displayed in a region of the image on the portable computing system 100 that is proximate the dealer 212 or the surface of the respective game table 211. In at least some instances, the resultant augmented reality format image may be created in whole or in part by the portable computing system 100, the back end system 204, or any combination thereof.

Data indicative of gaming information specific to the identified player may be retrieved or otherwise obtained from a gaming server 270. Such gaming information may include, for example data indicative of a player's win/loss rate or ratio, or any other game data, metrics, or analyses related to the activities of the player at the gaming table 211. Data indicative of game performance information specific to a gaming table 211 may also be retrieved or otherwise obtained from the gaming server 270. Such gaming information may include, for example, a table win/loss record or ratio, the number of game events (e.g., hands, deals, spins, rolls, etc.) over a defined time period, and the like. Data retrieved from the gaming server 270 may be provided to the portable computing system 100 for display in the real-time or near real-time image of the game table 211. Gaming information logically associated with a particular player 214, 216 appearing in the acquired still or video image data may be provided to game operating or management staff 102 in an augmented reality format where the information is incorporated into the image displayed on the portable computing system 100 and displayed spatially proximate the identified player 214, 216, game operating personnel 212, or game table 211. Gaming information logically associated with the game table 211 appearing in the acquired still or video image data may be provided in an augmented reality format and displayed in a region of the image on the portable computing system 100 that is proximate the game operating personnel 212 or the surface of the game table 211. In at least some instances, the resultant augmented reality format image may be created in whole or in part by one or more processors in the portable computing system 100, in the back end system 204, in one or more network locations or nodes (not shown in FIG. 2), or any combination thereof.

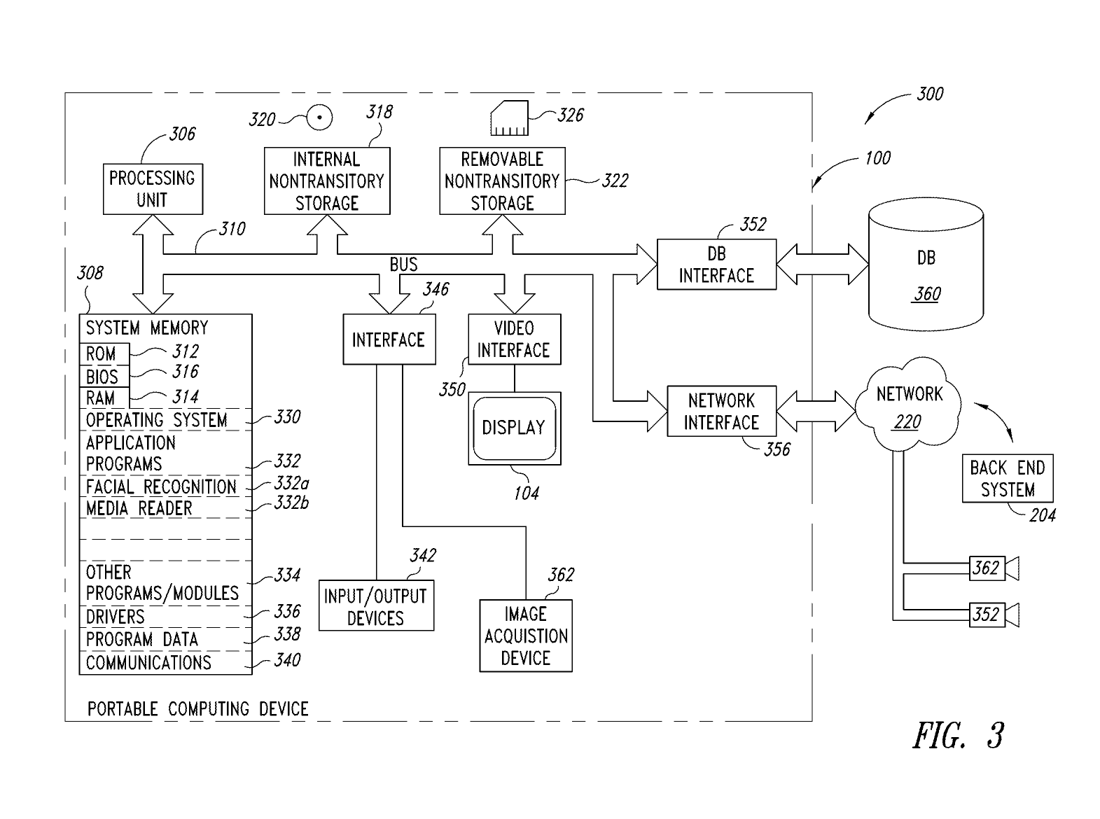

FIG. 3 and the following discussion provide a brief, general description of an exemplary portable computing system 100 that may be used on a gaming floor 202 to provide an augmented reality format image containing information logically associated with one or more players 214, 216; one or more game operating staff 212, or the game table 211 displayed in real-time or near real-time in a video or still image acquired using the portable computing system 100. The portable computing system 100 may implement some or all of the various functions and operations discussed immediately above in reference to FIGS. 1 and 2.

Although not required, some portion of the embodiments will be described in the general context of computer-executable instructions or logic, such as program application modules, objects, or macros being executed by a computer. Those skilled in the relevant art will appreciate that the illustrated embodiments as well as other embodiments can be practiced with other computer system configurations, including handheld devices for instance Web enabled cellular phones or PDAs, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be stored in both local and remote memory storage devices and executed using one or more local or remote processors, microprocessors, digital signal processors, controllers, or combinations thereof.

The portable computing system 100 may take the form of any current or future developed portable computing system capable of executing one or more instruction sets. The portable computing system 100 includes a processing unit 306, a system memory 308 and a system bus 310 that communicably couples various system components including the system memory 308 to the processing unit 306. The portable computing system 100 will at times be referred to in the singular herein, but this is not intended to limit the embodiments to a single system, since in certain embodiments, there will be more than one system or other networked computing device involved. Non-limiting examples of commercially available systems include, but are not limited to, an Atom, Pentium, or 80x86 architecture microprocessor as offered by Intel Corporation, a Snapdragon processor as offered by Qualcomm, Inc., a PowerPC microprocessor as offered by IBM, a Sparc microprocessor as offered by Sun Microsystems, Inc., a PA-RISC series microprocessor as offered by Hewlett-Packard Company, an A6 or A8 series processor as offered by Apple Inc., or a 68xxx series microprocessor as offered by Motorola Corporation.

The processing unit 306 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 2 are of conventional design. As a result, such blocks need not be described in further detail herein, as they will be understood by those skilled in the relevant art.

The system bus 310 can employ any known bus structures or architectures, including a memory bus with memory controller, a peripheral bus, and a local bus. The system memory 308 includes read-only memory (“ROM”) 312 and random access memory (“RAM”) 314. A basic input/output system (“BIOS”) 316, which can form part of the ROM 312, contains basic routines that help transfer information between elements within the portable computer system 100, such as during start-up. Some embodiments may employ separate buses for data, instructions and power.

The portable computer system 100 also includes one or more internal nontransitory storage systems 318. Such internal nontransitory storage systems 318 may include, but are not limited to, any current or future developed persistent storage device 320. Such persistent storage devices 320 may include, without limitation, magnetic storage devices such as hard disc drives, electromagnetic storage devices such as memristors, molecular storage devices, quantum storage devices, electrostatic storage devices such as solid state drives, and the like.

The portable computer system may also include one or more optional removable nontransitory storage systems 322. Such removable nontransitory storage systems 322 may include, but are not limited to, any current or future developed removable persistent storage device 326. Such removable persistent storage devices 326 may include, without limitation, magnetic storage devices, electromagnetic storage devices such as memristors, molecular storage devices, quantum storage devices, and electrostatic storage devices such as secure digital (“SD”) drives, USB drives, memory sticks, or the like.

The one or more internal nontransitory storage systems 318 and the one or more optional removable nontransitory storage systems 322 communicate with the processing unit 306 via the system bus 310. The one or more internal nontransitory storage systems 318 and the one or more optional removable nontransitory storage systems 322 may include interfaces or device controllers (not shown) communicably coupled between nontransitory storage system and the system bus 310, as is known by those skilled in the relevant art. The nontransitory storage systems 318, 322, and their associated storage devices 320, 326 provide nonvolatile storage of computer-readable instructions, data structures, program modules and other data for the portable computing system 100. Those skilled in the relevant art will appreciate that other types of storage devices may be employed to store digital data accessible by a computer, such as magnetic cassettes, flash memory cards, Bernoulli cartridges, RAMs, ROMs, smart cards, etc.

Program modules can be stored in the system memory 308, such as an operating system 330, one or more application programs 332, other programs or modules 334, drivers 336 and program data 338.

The application programs 332 may, for example, include one or more biometric analysis programs such as one or more facial recognition programs 332a capable of extracting facial data from the still or video images captured using the portable computing system 100. The application programs 332 may also include one or more media reader programs for reading casino player cards bearing magnetic strips or other identification devices or similar identification media carried by the players 214, 216. Such media reader programs may control the operation of one or more input/output devices, for example one or more radio frequency identification (RFID) interrogators, one or more near field communication (NFC) transceivers, or the like. The application programs 332 may, for example, be stored as one or more executable instructions.

The system memory 308 may also include other programs/modules 334, such as including logic for calibrating and/or otherwise training various aspects of the portable computing system 100. The other programs/modules 334 may additionally include various other logic for performing various other operations and/or tasks.

The system memory 308 may also include any number of communications programs 340 to permit the portable computing system 100 to access and exchange data with other systems or components, such as with the image acquisition device 362 and/or optionally with one or more other computer systems and devices such as one or more back end systems 204 as shown in FIG. 2.

While shown in FIG. 3 as being stored in the system memory 308, all or a portion of the operating system 330, application programs 332, other programs/modules 334, drivers 336, program data 338 and communications 340 can be stored on the persistent storage device 320 of the one or more internal nontransitory storage systems 318 or the removable persistent storage device 326 of the one or more optional removable nontransitory storage systems 322.

A user can enter commands and information into the portable computing system 100 using one or more input/output (I/O) devices 342. Such I/O devices 342 may include any current or future developed input device capable of transforming a user action or a received input signal to a digital input. Example input devices include, but are not limited to, a touchscreen, a physical or virtual keyboard, a microphone, a pointing device, a foot control or switch, or the like. These and other input devices are connected to the processing unit 306 through an interface 346 such as a universal serial bus (“USB”) interface communicably coupled to the system bus 310, although other interfaces such as a parallel port, a game port or a wireless interface or a serial port may be used. A display 104 or similar output device is communicably coupled to the system bus 310 via a video interface 350, such as a video adapter or graphical processing unit (“GPU”).

One or more output devices 342 may be communicably coupled to the interface 346. Such output devices may include one or more wireless radio frequency transceivers such as those used to interrogate or communicably couple to radio frequency identification (“RFID”) or near field communications (“NFC”) equipped devices external to the portable computing system 100. Example RFID and NFC devices can include, but are not limited to, casino player cards and the like.

The image acquisition device 362 may be a video camera, digital still camera, or other imaging device. In some embodiments, the image acquisition device may include a frame grabber or other device for capturing, buffering, converting, and/or otherwise obtaining digital color images for processing by the portable computing system 100 or by the back end system 204. In this illustrated embodiment, the image acquisition device 362 is shown as being connected to interface 346, although in other embodiments, the image acquisition device 362 may be connected to the portable computing system 100 using other means, such as via the network 220, via one or more intermediary devices, etc. In at least some instances, the image acquisition device 362 may include one or more fixed or moving surveillance cameras 5 or similar surveillance devices that can be accessed by the portable computing system 100 via the network 220.

Furthermore, although not illustrated here, the portable computing system 100 may include a triggering device and/or other mechanism for manually triggering acquisition or capture of an image via the image acquisition device 362, such as a push button, a foot control, etc. In some embodiments, the triggering device and/or other mechanism may be wiredly or wireless communicably coupled to the image acquisition device 362. Further, image acquisition may be automatically triggered by the portable computing system 100, such as based on a timer and/or an occurrence of another event, and/or may be remotely triggered via the network 220.

In some embodiments, the portable computing system 100 operates in an environment using one or more of the communications interfaces to optionally communicably couple to one or more remote computers, servers and/or other devices via one or more communications channels, for example, one or more networks such as the network 220. These logical connections may facilitate any known method of permitting computers to communicate, such as through one or more LANs and/or WANs. Such networking environments are well known in wired and wireless enterprise-wide computer networks, intranets, extranets, and the Internet. For example, in some embodiments, the portable computing system 100 may communicate with one or more additional image acquisition devices (not shown) via the network 220, such as for the purposes of acquiring or capturing images of gaming table(s) 211 and the players 214, 216 participating in the games conducted on the surface of the gaming table 211. In some further environments, the portable computing system 100 may be communicably coupled to one more other computing systems, networks, or devices, such as a back end system 204. A communicable coupling to one or more other computing systems, networks, or devices may be beneficial in providing the ability to receive indications to acquire or capture and/or evaluate images, and/or to provide information regarding evaluated images, such as information regarding the determined value of objects, etc. In at least some instances, the portable computing system

In some embodiments, the network interface 356, which is communicably coupled to the system bus 310, may be used for establishing communications over the network 220. Further, the database interface 352, which is communicably coupled to the system bus 310, may be used for establishing communications with a database stored on one or more computer-readable media 360. For example, such a database 260 may include a repository for storing information regarding object evaluation, color tables, object color-value relationship information, etc. In some embodiments, the database interface 252 may communicate with the database 260 via the network 214.

In the environments 10 and 200 (FIGS. 1 and 2, respectively), program modules, application programs, or data, or portions thereof, can be stored in another server computing system (not shown). Those skilled in the relevant art will recognize that the network connections shown in FIG. 3 are only some examples of ways of establishing communications between computers, and other connections may be used, including wirelessly. In some embodiments, program modules, application programs, or data, or portions thereof, can even be stored in other computer systems or other devices (not shown).

For convenience, the processing unit 306, system memory 308, network port 356 and interfaces 346, 352 are illustrated as communicably coupled to each other via the system bus 310, thereby providing connectivity between the above-described components. In alternative embodiments of the portable computing system 100, the above-described components may be communicably coupled in a different manner than illustrated in FIG. 3. For example, one or more of the above-described components may be directly coupled to other components, or may be coupled to each other, via intermediary components (not shown). In some embodiments, system bus 310 is omitted and the components are coupled directly to each other using suitable connections.

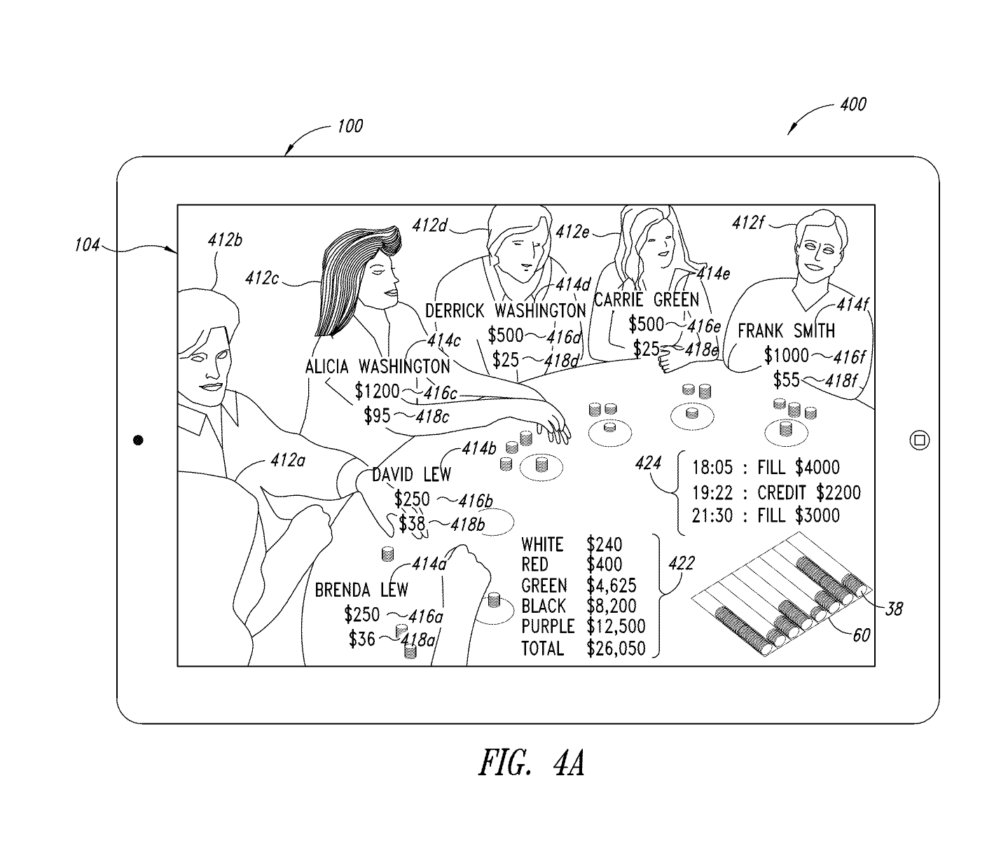

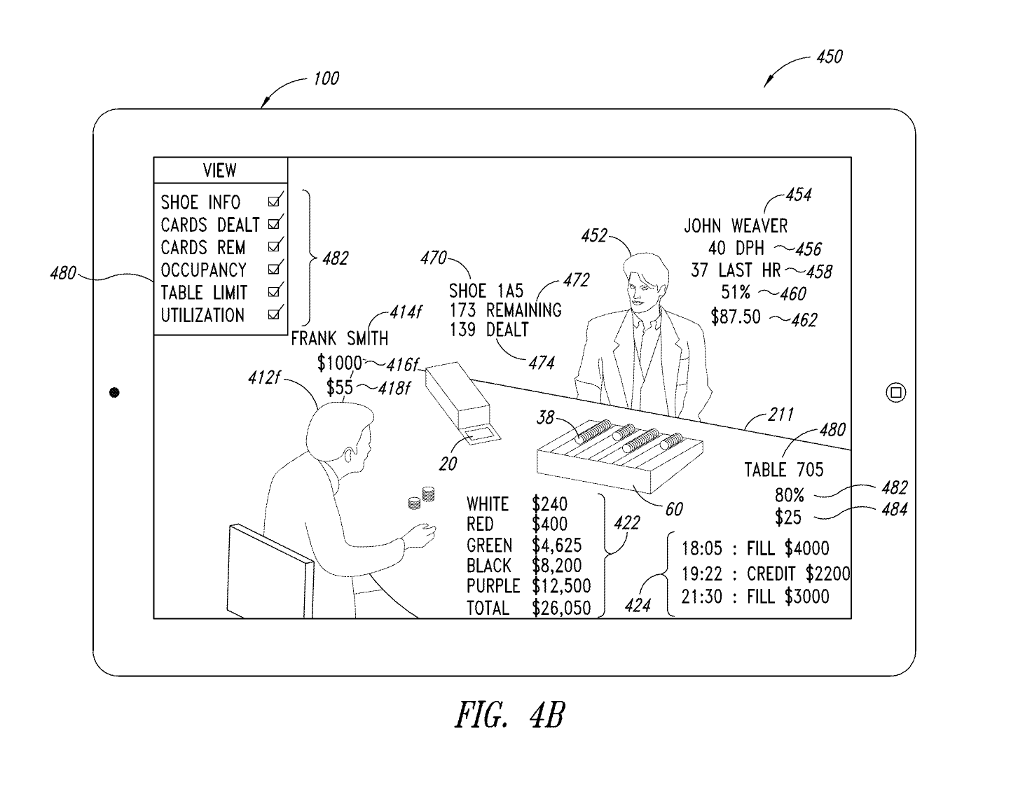

FIG. 4A is a screen print showing an augmented reality image 400 displayed on a tablet form-factor portable computing system 100. Six players 412a-412f (collectively “players 412”) are in attendance about a gaming table 211 in the still or video image captured or otherwise acquired by the portable computing system 100. Personal information in the form of each player's name 414a-414f (collectively “player name 414”) and financial information in the form of each player's buy-in to the table game 416a-416f (collectively “buy-in 416”) and average wager amount 418a-418f (collectively “average wager 418”) are displayed proximate the respective player 412. Gaming information in the form of the chip tray inventory 422 and the chip tray fill and credit history 424 are displayed proximate the chip tray 36. The combination of video or still image data acquired using the image acquisition device 362 and data associated with one or more players 412 or objects appearing in the image is in the form of an augmented reality format image that advantageously provides information about both the players and the game to the portable computing system user 102.

The personal information 414, financial information 416, 418, and gaming information 420, 422 that is combined with the still or video image data acquired by the portable computing system 100 can be provided in whole or in part using one or more databases or data stores in the system memory 308 of the portable computing system 100, in one or more back end systems 204, or any combination thereof. In at least some instances, the image processing algorithm to combine the data indicative of the personal information 414, financial information 416, 418, and gaming information 420, 422 with the still or video image data can be executed in whole or in part by the portable computing system 100, by one or more back end systems 204, or any combination thereof.

In at least some implementations, the personal 414 and financial information 416, 418 displayed proximate the player 412 may be logically associated with the identity of the player and not with the table position of the player. By logically associating such personal and financial information with a particular player 412 rather than the game table position occupied by the respective player, the personal and financial information logically associated with each player will be displayed proximate the player with whom the information is logically associated even should the players 412 change positions at the game table 211. Additionally, such logical associations enable the portable computing system 100 to track a single player 412 occupying more than one position at a game table 211 (e.g., playing two positions during a single hand dealt at a blackjack table).

The data indicative of player personal information displayed on the portable computing system 100 can include, but is not limited to, data indicative of: a name logically associated with the player 412 either obtained from a player database or player data store or acquired from piece of media or a similar identification device carried by the player; the player's eligibility to engage in games (e.g., has the player been banned from engaging in some or all game tables on the gaming floor); the player's status in one or more casino patron recognition programs (e.g., is the player a member of the casino “gold” or “platinum” loyalty clubs); statistical information associated with the gaming habits, wins, losses, or combinations thereof associated with the player; and, the number of casino reward points, comps, alternative comps, raffle tickets, promotional gaming awards, and promotional non-gaming awards accumulated by or awarded to the player.

Data indicative of player financial information can include, but is not limited to, data indicative of: a wagering history associated with the player over a defined interval of time or over a defined number of events (e.g., wagering history for current day, past hour, since entering the game table); the current wager amount placed by the player on the current instance of the game at the gaming table 210; the buy-in amount provided by the player upon entry to the gaming table 210; the average wager amount placed by the player over a defined interval of time or over a defined number of events; the number of game instances over a defined interval of time or over a defined number of events in which the player has participated by placing a wager (e.g., number of hands, number of spins, number of rolls); the speed or average speed of the player in participating in the game over a defined interval of time or over a defined number of game events; and the average hold amount for the player over a defined interval of time or over a defined number of events. The above listed player personal and financial information is illustrative in nature and not exhaustive. Data indicative of other player personal and financial information or combinations thereof may be displayed in an augmented reality format on the portable computing system display 104.

The data indicative of gaming information displayed on the portable computing system 100 can include, but is not limited to, data indicative of: a name or identity of each casino staff member directly involved in the play of the game either obtained from a database or data store or acquired from piece of media or similar device carried by the casino staff member; one or more efficiency metrics appropriate to the game being played at the game table 211 (e.g., hands per hour, rolls per hour, spins per hour); one or more win/loss metrics associated with the casino staff member(s) directly involved in the play of the game; a chip inventory of the chips currently held by the casino staff member involved in the play of the game being played at the game table 211 (e.g., the chip inventory in the chip tray at a blackjack table); a chip valuation of the chips currently held by the casino staff member involved in the play of the game being played at the game table 211 (e.g., the value of the chip inventory in the chip tray at a blackjack table); a refill or credit history of the chip inventory at the game table 211; an occupancy metric indicative of the number of players participating in the game over a defined number of game instances (e.g., 10 hands, 20 spins, or 20 dice throws) or a defined time (e.g., per hour); the casino win (amount wagered by player minus amount paid to player) associated with each player at the table over a defined interval of time or over a defined number of game events; the utilization of the gaming table (i.e., number of players divided by number of seats at the game table 210 over a defined interval of time or over a defined number of game events); the occupancy of the table (i.e., the number of players at the game table 211 over a defined interval of time or over a defined number of game events); and one or more efficiency metrics (e.g., actual number of game instances completed divided by theoretical maximum number of game instances completed) associated with the casino staff member(s) directly involved in the play of the game. The above listed gaming information is illustrative in nature and not exhaustive. Data indicative of other game financial metrics and game performance metrics or combinations thereof may be displayed in an augmented reality format on the portable computing system display 104.

In at least some instances data indicative of one or more calculated or algorithmically determined player financial, game financial, or game performance metrics may be displayed in an augmented reality format on the portable computing system display 104. One such player financial metric is exemplified by the “theoretical win” associated with a particular player participating in a table game. A formula for calculating the theoretical win (“TW”) is provided by:

TW=House Advantage×Decisions per Hour×Average Bet×Time Played (1)

Using such a formula on an illustrative example blackjack game where the house advantage is 0.52%, the game is being dealt at 60 hands per hour, and the player is placing an average bet of $50 per hand over a three hour period:

TW=0.52%×60×50×3=$46.80

The theoretical win may be used as one factor in assessing or otherwise evaluating the value of a player 412 to the casino. Players having a greater theoretical win may be considered by the casino or gaming establishment to represent someone having a greater value to the casino than a player having a lesser theoretical win. In recognition of their increased value, in at least some instances the theoretical win associated with such players may be used as a basis in determining the comps or similar rewards provided to the player.

In use, game management personnel 102 can travel between multiple game tables or other gaming devices or areas in the casino, using the portable computing system 100 to obtain information on one or more game performance or financial metrics associated with the game being played at the gaming table 211. Such information may include data indicative of the relative speed with which the game is progressing, thereby allowing floormen or pit bosses to proactively identify and correct games that progress at rates outside of defined acceptable limits (e.g., minimum number of hands, spins, or rolls per hour, etc.). Such information may include data indicative of the “bank” being maintained at the game table 211, thereby allowing floormen or pit bosses to add chips to a “thin” bank through a timely fill or remove chips from a “fat” bank through a timely credit in a manner that provides minimal impact or disruption to the flow of the game. Historical fill and credit information 424 may be displayed on the portable computing system 100.

FIG. 4B is another screen print showing an augmented reality image 450 displayed on a tablet form-factor portable computing system 100. One player 412f and a dealer 452 are in attendance about a gaming table 211 in the still or video image captured or otherwise acquired by the portable computing system 100. Personal information in the form of the player's name 414f and financial information in the form of the player's buy-in to the table game 416f and average wager amount 418f are displayed proximate the player 412f. Gaming information in the form of the chip tray inventory 422 and the chip tray fill and credit history 424 are displayed proximate the chip tray 36. Gaming information in the form of dealer's name 454, average number of hands per hour 456, number of hands in the last hour 458, winning percentage 460, and average winnings per player 462 are displayed spatially proximate the image of the dealer 452 in the still or video image captured or otherwise acquired by the portable computing system 100.

Additional gaming information regarding objects on the surface of the game table 211 may also be provided in augmented reality format. For example, information such as a card shoe identifier 470, the number of cards dealt from the shoe 472 and the number of cards remaining in the shoe 474 may be displayed spatially proximate a card shoe 20 appearing in the still or video image of a blackjack table captured or otherwise acquired by the portable computing system 100. Information logically associated with the gaming table 211 may also be displayed spatially proximate the gaming table 211. Such game table information may include a table identifier 480, the table utilization 482 (i.e., number of players divided by number of available seats), and the current table wager limit 484. The combination of video or still image data acquired using the image acquisition device 362 and data logically associated with the participants, game metrics, or game-related objects appearing in the image may be provided in an augmented reality format image where the information logically associated with a participant or gaming object is displayed spatially proximate the respective participant or gaming object.

Also shown in FIG. 4B is a drop down menu 480 providing a number of user selectable items 482 (e.g., checkboxes or selectable icons) for selecting the personal and game information is displayed by the portable computing system 100. In at least some implementations, the menu 480 may be context sensitive, displaying information options relevant to only those participants or objects present in the acquired still or video image. For example, information options logically associated with game operating personnel will not be included in the menu 480 when game operating personnel are not present in the acquired still or video image. For example, one or more pop-up or pull-down type menus may be used to access a list containing all available game performance and financial information and all available player personal or financial displayable by the portable computing system 100. The device user 102 can then select various parameters for display in augmented reality format described above and shown in FIGS. 4A and 4B. Such flexibility advantageously permits the use of a single portable computing system 100 to monitor multiple different table games 10 and also to display different data that is logically associated with and relevant to each respective table game 10.

In at least some instances, the game performance and financial information and the player personal or financial information displayed in augmented reality format by the portable computing system 100 may be logically associated with the game table identifier, one or more game table parameters (e.g., the wager limit amount at the table, the number of participants at the table, etc.), one or more player parameters, or any other number or type of defined parameters (e.g., time of day, day of week, game promotional offers, etc.). The parameters used to select which information is displayed in augmented reality format may include the parameters that are logically associated with information having the greatest relevancy to the game in progress on the table. Such parameters may be automatically selected by the portable computing system 100, by a back end system 204, or any combination thereof.

For example, during the afternoon a blackjack table may have a $5 limit and a new dealer staffing the table. During the afternoon, a greater emphasis may be placed on game performance and financial information (i.e., data indicative of the performance of the dealer) than player financial data since the table limit is set at a relatively low amount. However during the evening, the same blackjack table may now have a $50 limit and an experienced dealer staffing the table. During the evening, a greater emphasis may be placed on player personal and financial information (i.e., data indicative of the player to assist in creating a favorable environment for the higher-stakes participants) than the game performance information since an experienced dealer is now at the table. In such situations, even though the table and game are the same, the handheld computing system 100 may be configured to automatically display different player and game information based on the time of day and/or the current limit at the particular table.

In another example, the information displayed in augmented reality format by the portable computing system may be automatically determined based at least in part on one or more detected game financial or performance metrics. For example, in response to a detected irregularity in game outcome associated with a particular table or dealer (e.g., an unusual number of wins or losses or an unusual cash out pattern) the portable computing system 100 may autonomously display data indicative of game financial metrics when the particular game table 211 is identified in the image acquired by the portable computing system 100 or when the particular dealer is identified in the image acquired by the portable computing system 100.

In yet another example, the information displayed in augmented reality format by the portable computing system 100 may be automatically determined by the portable computing system 100, by one or more back end systems 204, or both based at least in part on one or more detected player personal or financial metrics. For example, in response to a historical pattern of irregular behavior by a player, a back end system may autonomously cause the portable computing system 100 to display data indicative of player financial metrics when the particular player is identified in the image acquired by the portable computing system 100. In some instances, such may allow game management personnel 102 to proactively identify players exhibiting detrimental behaviors such as those attributable to gambling addiction. In some instances, the portable computing system 100 may provide a notification or alert in the form of audible, visual, or tactile feedback to the game management personnel using the system to call attention to, highlight, or otherwise emphasize one or more participants present in the image and/or information logically associated with one or more participants present in the image.

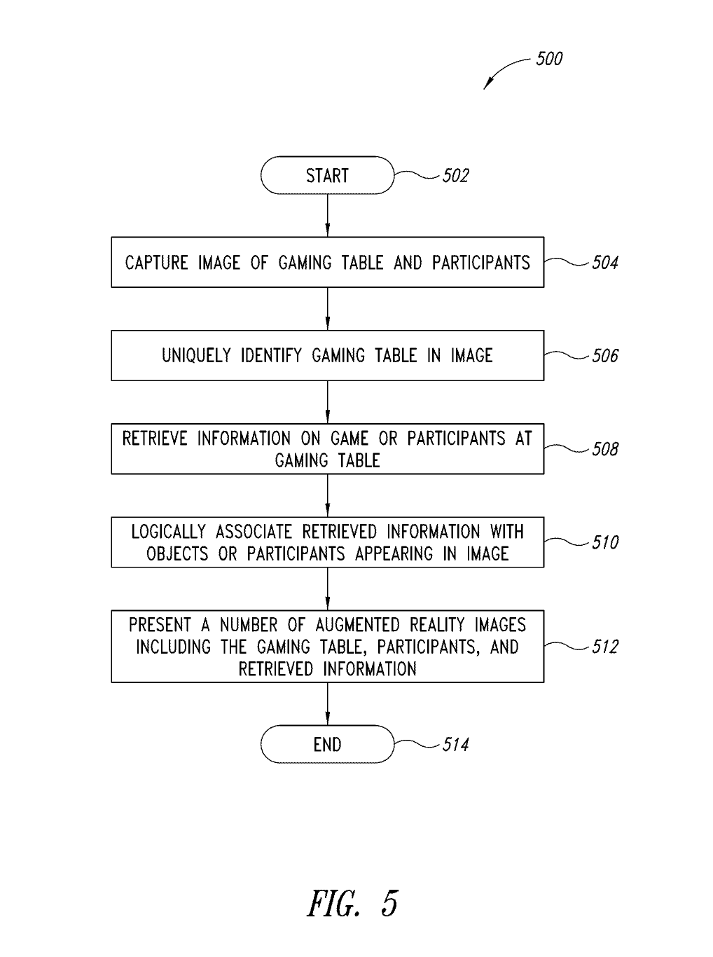

FIG. 5 shows a high level method 500, according to one illustrated embodiment, of providing an augmented reality image on a portable computing system 100 to provide an augmented reality game monitoring system. As discussed above, game management personnel, for example floormen, pit bosses, or pit managers may monitor player and/or gaming activity occurring at a game table 211 using an augmented reality format image provided by a portable computing system 100. In operation, some or all of the computing resources used to support the augmented reality format image on the portable computing system 100 may be sourced natively from the portable computing system 100, remotely from one or more systems or devices present in the back end system 204, or any combination of native and remote computing resources may be used.

In operation, an image acquisition device captures a still or moving (e.g., video) image of the gaming table 211 and the participants 412 participating in the game played on the gaming table 211. The image acquisition device may be located in the portable computing system 100. The user operating the portable computing system 100, an external device (e.g., a radio frequency identification or “RFID” transponder) or data in the acquired image may uniquely identify the game table 211 appearing in the acquired image data. External data (e.g., a player card or RFID tag) or data in the acquired image may be used to identify some or all of the participants including players 412 and game operations personnel in attendance at the game table 211.

Data indicative of information logically associated with and relevant to the game or game participants can be generated or otherwise accessed and displayed in the acquired image of the game table 211 and participants. Such information may be logically associated with the table, one or more objects on the table, or the individual participants in attendance at the table. The information can be displayed in or incorporated into the acquired still or video image of the game table 211 on a real-time or near real-time basis. The information can be displayed at a location in the video or still image spatially proximate the table, object, or participant with which the information is logically associated. Display of augmented reality format images may be used advantageously by game management personnel 102 to ensure smooth operation of the game as well as to assist in providing prompt, personalized service to the players 412 at the game table 211. The method starts at 502, for example in response to turning on of the portable computing system 100 or selection of a user selectable icon by an end user.

At 504, data representative of a video or still image of a game table 211 and a number of game participants, including players 412 and game operating staff, is acquired by the image capture device and communicated to the portable computing system 100. In some instances, the portable computing system 100 may include an onboard digital camera used to acquire the data representative of the moving or still images of the game table 211. A still image of the game table 211 and the game participants can be acquired in any current or future developed image format including RAW, TIFF, JPEG, or the like. A video image of the game table 211 and game participants can be acquired in any current or future developed video format including MP4, WMV, or the like. In at least some instances all or a portion of the data representative of the image data acquired by the portable computing system 100 can be archived or otherwise stored in whole or in part on the portable computing system 100, on a back end system 204, or any combination thereof.

At 506, the game table 211 appearing in the image data acquired by the image acquisition device is identified. A casino or gaming establishment may have any number of nearly identical, gaming tables 211 distributed across the gaming floor 202. Accurate identification of a game table 211 therefore permits the compilation of gaming data on a per table basis. In some instances, the user of the portable computing system 100 may manually enter unique table identification information using one or more input devices, for example a virtual keyboard on a tablet form-factor portable computing system 100. In other instances, each game table 211 may carry one or more unique identifiers, for example a machine readable symbol such as a bar code symbol, quick reference (“QR”) code symbol, or the like which may be printed or otherwise disposed in, on, or about the game table 211 in a location or using media invisible to the players 412. In such instances, the portable computing system 100 can detect the presence of the machine readable symbol in the acquired image data and use the machine readable symbol to identify the game table 211 appearing in the image. In yet other instances, some or all of the game table(s) 211 may include a wireless transponder (e.g., a radio frequency transponder) that broadcast a unique identifier detectable by the portable computing system 100. In such instances, the portable computing system 100 may include a receiver or device interrogator (e.g., an RFID interrogator) that may be used to obtain the identification information associated with a respective game table 211.

At 508, participants in attendance at the game table 211 and appearing in the acquired image data are identified. Such participants may include both players 414, 416 and game operating staff 412 such as dealers, croupiers, and the like. In at least some implementations, some or all of the participants in attendance at the game table 211 may be identified using media carried by the respective participant. For example, operating staff may carry identification cards or similar identification media readable or detectable by the portable computing system 100. Such media may include RF transmitters or transponders that may either broadcast a unique identification signal or respond with a unique identification signal upon interrogation. Players may carry or present player club cards, rewards cards, or other identification media capable of uniquely identifying the player. Such media may be directly read by the portable computing system 100, for example via an RF interrogation routine, or may be read using an external device such as a card reader (e.g., a magnetic stripe card reader) located at the game table 211 with the data acquired from the media communicated to the portable computing system 100.

In other instances, one or more biometric recognition techniques may be used to identify some or all of the participants in attendance at the game table 211. Such biometric recognition technology may include facial recognition of one or more players 214, 216 appearing in the data representative of the acquired still or video image of the gaming table 211. The use of autonomous identification technology such as facial recognition may be advantageously accomplished with minimal or no disruption to flow of the game on the game table 211.

After the participants in attendance at the gaming table 211 are identified, data indicative of information associated with each participant may be generated or otherwise acquired by the portable computing system. In some instances, at least a portion of the data may be acquired or otherwise obtained by the portable computing system 100. In at least some instances, all or a portion of such information may be obtained from the data representative of the image acquired by the portable computing system 100, for example determining the value of a player's chips using an object stack analysis technology. In other instances, all or a portion of such information may be obtained from one or more back end systems 204, for example, one or more player tracking servers 250, one or more accounting servers 260, or one or more gaming servers 270. Data obtained from a back end system 204 may be wiredly or wirelessly transmitted to the portable computing system 100, using for example a local area network, a wide area network, or a worldwide network such as the Internet.

At 510, the information for each participant in attendance at the gaming table that is obtained by the portable computing system 100 is logically associated with the respective participant. For example, personal information such as a player's name and one or more express or inferred preferences obtained from a player tracking server 250 is logically associated with the player included in the data representative of the acquired still or video image of game table 211. Personal financial information such as a player's win/loss total, theoretical win, wager history, and other financial based metrics obtained from a back end system 204, an accounting server 260, or gaming server 270 may be logically associated with the player included in the data representative of the acquired still or video image of game table 211 or other gaming machine, gaming device, or gaming location.

Additionally, game financial information, for example a chip inventory, value, and credit/fill history may be logically associated with an object, such as the chip tray or bank, appearing in the data representative of the acquired still or video image of the gaming table 211. Game performance information, for example a dealer's efficiency, win/loss record, and other financial or performance based metrics is logically associated with at least one participant, for example the dealer at a blackjack table, appearing in the acquired data representative of the acquired still or video image of the gaming table 211.

One or more data structures in which data indicative of some or all of the participants in attendance at the gaming table 211 and personal or financial information logically associated with each of the identified participants may be constructed by or stored within the system memory 308 of the portable computing system 100 or in one or more back end systems 204 communicably coupled to the portable computing system 100. Additionally data indicative of game financial or performance metrics logically associated with one or more objects appearing in the image of the gaming table may be constructed or stored within the system memory 308 of the portable computing system 100 or in one or more back end systems 204 communicably coupled to the portable computing system 100.

At 512, data indicative of personal and financial information logically associated with some or all of the participants appearing in the acquired still or video image of the gaming table 211 is overlaid on or inserted into data representative of the acquired still or video image in a location spatially proximate the respective participant with whom the personal and financial information is logically associated. Additionally, data indicative of game performance and financial information logically associated with one or more objects appearing in the acquired still or video image of the gaming table 211 is inserted into or overlaid on the data representative of the acquired still or video image in a location spatially proximate the respective object with which the personal and financial information is logically associated.

In some instances, the display of data indicative of the personal and financial information logically associated with some or all of the game participants and the data indicative game performance and financial information included logically associated with the game table and/or game objects may result in the presentation of a considerable quantity of information in the augmented reality format image. In such instances, one or more information display parameters (e.g., size, style, font, and the like) may be altered or adjusted to more clearly present the information in the image. For example, the text size of the information may be based at least in part on the distance between the portable computing system 100 and the participant, game table, or game object such that information logically associated with participants, game tables, and game objects positioned further from the system is displayed in a smaller text size than the displayed information that is logically associated with participants, game tables, and game objects positioned closer to the system 100. In another example, the information for each respective participant, game table, and game object appearing in the augmented reality format image may be displayed in a different color and an indicator in the corresponding color may be positioned on or about the participant, game table, or game object with which the information is logically associated. In yet another example, the location of the information logically associated with each respective participant, game table, and game object appearing in the augmented reality format image may be positioned such that the overlap of such information in the augmented reality format image is minimized or eliminated.

The acquired video or still image including the inserted personal and financial information logically associated with some or all of the participants and the inserted game performance and financial information that is logically associated with one or more objects is displayed to the user of the portable computing system 100 as an augmented reality image. The method concludes at 514.

FIG. 6 shows a method 600, according to one illustrated embodiment, of manually identifying a gaming table which may be employed in the performing the table identification of the method of FIG. 5. In at least some instances, some or all of the gaming table(s) 211 present on the gaming floor 202 may not be equipped with one or more devices or features enabling the automatic identification of the table by the portable computing system 100. In such instances, the user of the portable computing system 100 may manually enter a unique identifier associated with the gaming table 211. Such manual entry may be accomplished using any form of data input, including but not limited to a virtual keyboard appearing on the display 104 of the portable computing system 100, a physical keyboard communicably coupled to the portable computing system 100, voice entry, or any other data entry method. The method commences at 602.

At 604, the user manually enters a unique identifier for the gaming table 211 appearing in the video or still image acquired by the portable computing system 100. The method concludes at 606.

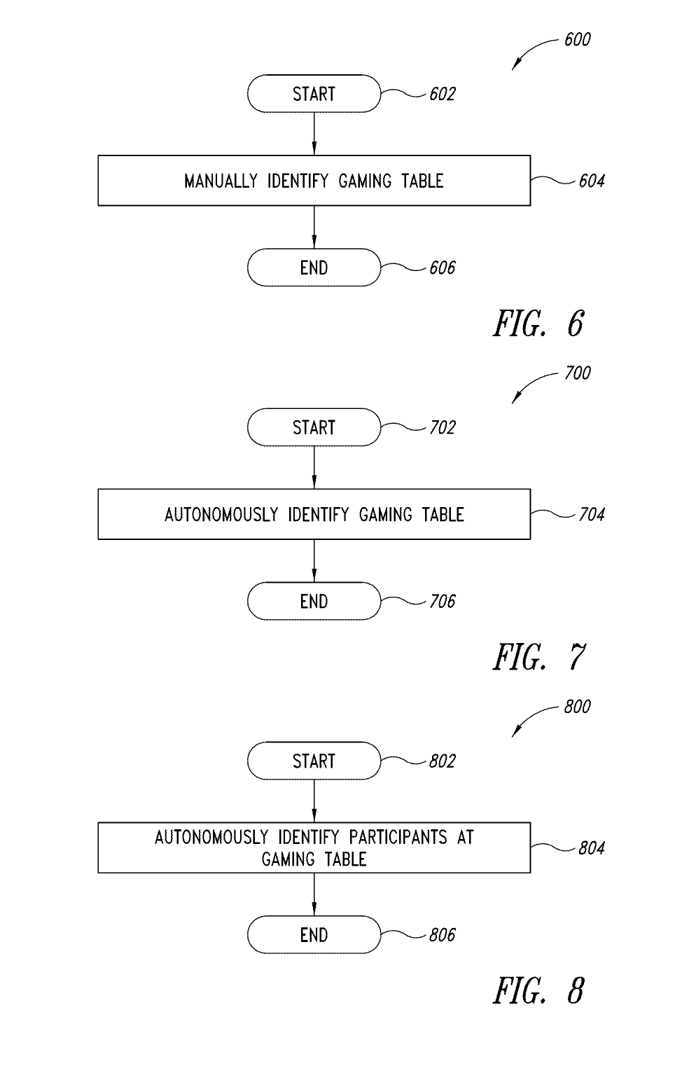

FIG. 7 shows a method 700, according to one illustrated embodiment, of automatically identifying a gaming table which may be employed in the performing the table identification of the method of FIG. 5. In at least some instances, some or all of the gaming table(s) 211 present on the gaming floor 202 may not be equipped with one or more devices or features enabling the automatic identification of the table by the portable computing system 100. In other instances, one or more position locating systems may be used by the portable computing system 100 to determine a relative location on the game floor 202 or an absolute position, for example a longitude and latitude. In such instances, the portable computing system 100 automatically obtains a unique identifier associated with the gaming table 211 appearing in the still or video image acquired by the portable computing system 100. The method commences at 702.

At 704, the portable computing system 100 automatically identifies a gaming table 211 appearing in the still or video image acquired by the portable computing system 100. In some instances, such automatic game table identification is accomplished using one or more machine readable symbols visible in the acquired still or video image. Such machine readable symbols can include any current or future developed machine readable symbols including bar code symbols, QR code symbols, and similar optical symbols. Such machine readable symbols may be human perceivable (i.e., detectable in the visible electromagnetic spectrum) or non-human perceivable (i.e., detectable in the non-visible electromagnetic spectrum, for example the ultraviolet or infrared electromagnetic spectrum). In some implementations, the data contained in the machine readable symbol may be sufficient to uniquely identify the gaming table 211 with which it is associated. In other implementations, the data contained in the machine readable symbol may provide data to the portable computing system 100 that enables the system to look-up or otherwise determine the identifier associated with the game table 211, for example in a database or data store locally accessible or remotely accessible (e.g., on a server in a back end system 204) by the portable computing system 100.

In other instances, such automatic game table identification is accomplished using one or more positioning systems detectible by the portable computing system 100. Such positioning systems may include a local positioning system providing the ability to determine a location relative to the game floor 202. Such local positioning systems may be realized, for example, through the use of a triangulation or time-of-flight system using radio beacons in a precisely defined matrix or pattern across or about the game floor 202. Once the location of the portable computing system 100 on the game floor 202 is identified, the system look-ups or otherwise determines the identifier associated with the game table 211 closest to the identified location on the game floor 202. In other instances, the orientation of the portable computing system 100 (i.e., the position of the system and the direction in which the system is pointed when the video or still images are acquired) may be used to determine the unique identifier associated with the game table 211 appearing in the acquired still or video image.

Such positioning systems may include a global positioning system (“GPS”) providing the ability to determine an absolute location on the surface of the earth. Such GPS information may be obtained using a GPS receiver on board or communicably coupled to the portable computing system 100. Once the absolute location of the portable computing system 100 is identified, the system look-ups or otherwise determines the identifier associated with the game table 211 closest to the identified location. In other instances, the orientation of the portable computing system 100 (i.e., the position of the system and the direction in which the system is pointed when the video or still images are acquired) may be used to determine the unique identifier associated with the game table 211 appearing in the acquired still or video image. The method concludes at 706.

FIG. 8 shows a method 800, according to one illustrated embodiment, of automatically identifying a participant at a gaming table which may be employed in the performing the method of FIG. 5. The participants appearing in the acquired still or video image may include any number of players and any number of operational staff responsible for administering one or more aspects of the game played on the game table 211. Data indicative of player personal and financial information is logically associated with and displayed proximate a particular player present at the game table in the acquired still or video image in the augmented reality format image displayed by the portable computing system 100. Similarly, data indicative of game performance or financial information is logically associated with and displayed proximate a particular operating staff member or object present at the game table in the acquired still or video image in the augmented reality format image displayed by the portable computing system 100. The method commences at 802.

At 804, the portable computing system 100 automatically identifies some or all of the participants in attendance at the gaming table 211. In some instances, not all of the participants may appear in the still or video image acquired by the portable computing system 100. For example, the players may appear in the still or video image while one or more of the operating staff do not appear in the still or video image. Some or all of the participants may be autonomously identified by the portable computing system 100, the back end system 204 or any combination thereof using one or more detection techniques or systems. For example, some or all of the operating personnel and players may be uniquely identified by a piece of media such as an employee badge or frequent player card carried by the participant. Such media may be read using a dedicated reader at the gaming table 211 and the information so obtained communicated to the portable computing system 100 via one or more networks. Such media may be read by the portable computing system 100, for example using a radio frequency receiver or transceiver acting as a radio frequency interrogator.

In at least some instances, some or all of the participants may be autonomously identified using one or more biometric detection devices or algorithms. For example, some or all of the participants in attendance at the gaming table 211 may be identified using hardware based biometric scanning devices located at or proximate the game table 211. Such hardware based biometric scanning devices can take the form of any current or future developed biometric scanning technology including, but not limited to, retinal scanners, fingerprint scanners, and the like. In at least some instances, biometric information may be obtained from the data indicative of the still or video image data acquired by the portable computing system 100. In at least one implementation, biometric information may be obtained using one or more facial recognition algorithms executed by the portable computing system 100, the back end system 204, or any combination thereof. Such facial recognition algorithms may be performed using the data representative of a participant's face appearing in the still or video images acquired by the portable computing system 100.

In other implementations, participants may be autonomously identified using any combination of technologies including facial recognition technologies executed by the portable computing system 100, a back end system 204, or combinations thereof. The method concludes at 806.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other systems, not necessarily the exemplary object evaluation system generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of physical signal bearing media include, but are not limited to, the following: recordable type media such as floppy disks, hard disk drives, CD ROMs, digital tape, and computer memory.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet that are commonly assigned to the same assignee of this application, including U.S. provisional patent application Ser. No. 61/829,077, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A method of operation in an augmented reality based system that employs a tablet form factor processor-based device for monitoring casino gaming, the method comprising:
capturing a plurality of images of a gaming area with at least one imager of the tablet form factor processor-based device, the images including at least a portion of a gaming table and one or more participants playing a game at the gaming table;
uniquely identifying the gaming table in the captured images;
retrieving information about at least one of the games currently being played at the gaming table or at least one of the participants playing the game at the gaming table;
logically associating the retrieved information with one or more physical objects represented in the captured images, the physical objects including at least one of: the gaming table, portions of the gaming table, one or more game playing objects on the gaming table, or the participants playing the game at the gaming table;
identifying at least one of the participants playing at the gaming table by reading patron loyalty tracking information from patron loyalty tracking media within a range of the tablet form factor processor-based device, the reading being performed by the tablet form factor processor-based device; and
presenting a number of augmented reality images via a display of the tablet form factor processor-based device, the augmented reality images including an image of at least a portion of the gaming table including the one or more participants along with at least one virtual reality object that is spatially associated in the augmented reality images with respective ones of the one or more physical objects to which the at least one virtual reality object respectively pertains.

2. The method of claim 1 wherein uniquely identifying the gaming table in the captured images includes at least one of receiving information via a touch screen of the tablet form factor processor-based device that includes a unique gaming table identifier, receiving geo-location information by the tablet form factor processor-based device, determining a direction by the tablet form factor processor-based device, or determining an orientation of the tablet form factor processor-based device.

3. The method of claim 1 wherein uniquely identifying the gaming table in the captured images includes decoding information from a machine-readable symbol that appears in at least one of the captured images.

4. The method of claim 1 wherein uniquely identifying the gaming table in the captured images includes wirelessly receiving information from a wireless transponder that is physically associated with the gaming table.

5. The method of claim 1 wherein identifying at least one of the participants playing at the gaming table includes determining a name of a respective participant for each of a number of occupied positions at the gaming table by reading respective patron loyalty tracking information from respective patron loyalty tracking media within a range of the tablet form factor processor-based device by the tablet form factor processor-based device.

6. The method of claim 1, further comprising:
identifying a dealer at the gaming table by reading dealer identification information from a piece of dealer identification media within a range of the tablet form factor processor-based device by the tablet form factor processor-based device.

7. The method of claim 1 wherein presenting a number of augmented reality images via a display of the tablet form factor processor-based device includes providing spatially proximate an image of at least one participant or a respective wagering placement area associated with the at least one participant at least one virtual object in the form of a name of that respective participant.

8. The method of claim 1 wherein presenting a number of augmented reality images via a display of the tablet form factor processor-based device includes providing spatially proximate an image of at least one participant or a respective wagering placement area associated with the at least one participant at least one virtual object in the form of a current wager amount placed by that respective participant.

9. The method of claim 1 wherein presenting a number of augmented reality images via a display of the tablet form factor processor-based device includes providing spatially proximate an image of at least one participant or a respective wagering placement area associated with the at least one participant at least one virtual object in the form of accumulated playing statistics for that respective participant for play over a period of time including; at least one of: an average wager, a number of hands played, a rate of hands played, or an average hold amount for that respective participant.

10. The method of claim 1 wherein presenting a number of augmented reality images via a display of the tablet form factor processor-based device includes providing spatially proximate an image of at least one participant or a respective wagering placement area associated with the at least one participant at least one virtual object in the form of a notification that the respective participant is banned from play.

11. A method of operation in an augmented reality based system that employs a tablet form factor processor-based device for monitoring casino gaming, the method comprising:
capturing a plurality of images of a gaming area with at least one imager of the tablet form factor processor-based device, the images including at least a portion of a gaming table and one or more participants playing a game at the gaming table;
uniquely identifying the gaming table in the captured images;
retrieving information about at least one of the games currently being played at the gaming table or at least one of the participants playing the game at the gaming table;
logically associating the retrieved information with one or more physical objects represented in the captured images, the physical objects including at least one of: the gaming table, portions of the gaming table, one or more game playing objects on the gaming table, or the participants playing the game at the gaming table; and
presenting a number of augmented reality images via a display of the tablet form factor processor-based device, the augmented reality images including an image of at least a portion of the gaming table including the one or more participants along with at least one virtual reality object that is spatially associated in the augmented reality images with respective ones of the one or more physical objects to which the at least one virtual reality object respectively pertains, wherein presenting a number of augmented reality images via a display of the tablet form factor processor-based device includes providing spatially proximate an image of at least one dealer or a respective position the at least one dealer occupies a first virtual object in the form of an indication of an efficiency of the dealer at dealing games.

12. The method of claim 11 wherein presenting a number of augmented reality images via a display of the tablet form factor processor-based device includes providing spatially proximate an image of at least one dealer or a respective position the at least one dealer occupies at least one virtual object in the form of an indication of win/loss measurement for the dealer.

13. The method of claim 11 wherein presenting a number of augmented reality images via a display of the tablet form factor processor-based device includes providing spatially proximate an image of a bank at the table at least one virtual object in the form of an indication of a time of last refill of the bank.

14. The method of claim 11 wherein presenting a number of augmented reality images via a display of the tablet form factor processor-based device includes providing spatially proximate an image of a bank at the table at least one virtual object in the form of a user selectable icon selection of which produces a refill signal indicative of a request to refill the bank.

15. The method of claim 11 wherein presenting a number of augmented reality images via a display of the tablet form factor processor-based device includes providing spatially proximate an image of a bank at the table at least one virtual object in the form of an indication of a fill and credit history for the bank.

16. An augmented reality based system to monitor casino gaming, the augmented reality based system comprising:
a tablet form factor processor-based device, comprising:
at least one processor;
at least one non-transitory processor-readable medium communicatively coupled to the at least one processor, and which stores at least one of instructions or data for execution by the at least one processor;
at least one imager communicatively coupled to the at least one processor and operable to capture a plurality of images of a gaming area, the images including at least a portion of a gaming table and one or more participants playing a game at the gaming table;
at least one display communicatively coupled to the at least one processor, and
at least one radio communicatively coupled to the at least one processor; and
at least one antenna communicatively coupled to the at least one radio and operable to exchange information with a number of remote devices,
wherein the at least one processor:
uniquely identifies the gaming table in the captured images;
retrieves information about at least one of the games currently being played at the gaming table or at least one of the participants playing the game at the gaming table;
logically associates the retrieved information with one or more physical objects represented in the captured images, the physical objects including at least one of: the gaming table, portions of the gaming table, one or more game playing objects on the gaming table, or the participants playing the game at the gaming table;
identifies at least one of the participants playing at the gaming table by reading patron loyalty tracking information from patron loyalty tracking media within a range of the tablet form factor processor-based device, the reading being performed by the tablet form factor processor-based device; and
presents a number of augmented reality images via the display, the augmented reality images including an image of at least a portion of the gaming table including the one or more participants along with at least one virtual reality object that is spatially associated in the augmented reality images with respective ones of the one or more physical objects to which the at least one virtual reality object respectively pertains.

17. The augmented reality based system of claim 16 wherein the at least one processor of the tablet form factor processor-based device decodes information from a machine-readable symbol that appears in at least one of the captured images and that unique identifies the gaming table, or the at least one radio wirelessly receives information from a wireless transponder that is physically associated with the gaming table and that uniquely identifies the gaming table.

18. The augmented reality based system of claim 16 wherein the at least one processor of the tablet form factor processor-based device determines a name of a respective participant for each of a number of occupied positions at the gaming table based on respective patron loyalty tracking information read from respective patron loyalty tracking media by the at least one radio of the tablet form factor processor-based device.

19. The augmented reality based system of claim 16 wherein the at least one processor of the tablet form factor processor-based device identifies a dealer at the gaming table based on dealer identification information read from a piece of dealer identification media by the at least one radio of the tablet form factor processor-based device.

20. The augmented reality based system of claim 16 wherein the at least one processor of the tablet form factor processor-based device causes a presentation of at least one virtual object in the form of a name of a respective participant spatially proximate an image of the respective participant or a respective wagering placement area associated with the respective participant, and at least one of: a current wager amount placed by a respective participant spatially proximate an image of the respective participant or a respective wagering placement area associated with the respective participant, or accumulated playing statistics for a respective participant for play over a period of time spatially proximate an image of the respective participant or a respective wagering placement area associated with the respective participant, the accumulated playing statistics including at least one of at least one of average wager, number of hands played, rate of hands played, or average hold amount for a respective participant spatially proximate an image of the respective participant or a respective wagering placement area associated with the respective participant.

21. The augmented reality based system of claim 16 wherein the at least one processor of the tablet form factor processor-based device causes a presentation of at least one virtual object in the form of a notification that a respective participant is banned from play spatially proximate an image of the respective participant or a respective wagering placement area associated with the respective participant.

22. The augmented reality based system of claim 16 wherein the at least one processor of the tablet form factor processor-based device causes a presentation of at least one virtual object in the form of an indication of an efficiency of a dealer at dealing games spatially proximate an image of the respective dealer or a respective position the respective dealer occupies.

23. The augmented reality based system of claim 16 wherein the at least one processor of the tablet form factor processor-based device causes a presentation of at least one virtual object in the form of an indication of current contents of a bank spatially proximate an image of the bank at the table.

24. The augmented reality based system of claim 16 wherein the at least one processor of the tablet form factor processor-based device causes a presentation of at least one virtual object in the form of a time of last refill of a bank spatially proximate an image of the bank at the table.

25. The augmented reality based system of claim 16 wherein the at least one processor of the tablet form factor processor-based device causes a presentation of at least one virtual object in the form of a user selectable icon selection of which produces a refill signal indicative of a request to refill a bank spatially proximate an image of the bank at the table.

26. The augmented reality based system of claim 16 wherein the at least one processor of the tablet form factor processor-based device causes a presentation of at least one virtual object in the form of an indication of a fill and credit history for a bank spatially proximate an image of the bank at the table.
